(19) United States
(12) Patent Application Publication
(10) Pub. No.: US 2011/0103961 A1
(43) Pub. Date: May 5, 2011

(54) METHOD OF PRODUCING AN OXIDE DISPERSION STRENGTHENED NICKEL-BASE SUPERALLOY

(75) Inventors: Neil E. GLOVER, Matlock (GB); Catherine M.F. RAE, Cambridge (GB); Mark C. HARDY, Belper (GB); Robert J. MITCHELL, Nottingham (GB)

(73) Assignee: ROLLS-ROYCE PLC, London (GB)

(21) Appl. No.: 12/891,188

(22) Filed: Sep. 27, 2010

(30) Foreign Application Priority Data
Nov. 4, 2009 (GB) 0919320.2

(51) Int. Cl. B64C 27/46; C23C 4/10; B32B 15/04; B22F 1/00

(52) U.S. Cl. 416/223 R; 427/453; 428/472; 428/469; 419/64

(57) ABSTRACT

A method of producing an oxide dispersion strengthened nickel-base superalloy, comprising introducing an oxide dispersoid material into a plasma gun of a plasma spray apparatus, where it is sublimed and turned to vapour; and introducing a nickel-base superalloy material into the plasma spray apparatus at a cooler location, downstream of the plasma gun, such that the oxide dispersoid material condenses on the superalloy material to produce the oxide dispersion strengthened nickel-base superalloy.

Nickel-base superalloys are known. These superalloys exhibit excellent mechanical strength and creep resistance at high temperature. Such superalloys have a two-phase equilibrium microstructure, consisting of γ and γ′. The γ′ is largely responsible for excellent mechanical strength and creep resistance at high temperature. As a result of their properties, nickel-base superalloys have found application in the aerospace industry.

Oxide dispersion strengthening (ODS) of superalloys is also known. Such ODS alloys are currently produced by the mechanical alloying process. Powders of oxide, elemental metals and alloys are mixed in a high-energy ball mill to form composite powders with the dispersoid. Ingots are then obtained by hot extrusion.

Alloys produced in this fashion, i.e. ODS alloys, have typically been used to produce directional property structures such as turbine blades and sheet materials for static structures.

Unfortunately, the ball milling step required to produce the ODS powder blend may cause the nickel powders to fuse together or fracture. It is very difficult to ball mill a highly alloyed material, containing a significant γ′ volume fraction which is ‘strong’. Further, the material may itself become contaminated from the ball mill and ultimately compromise component integrity. In addition, the powder that is produced requires subsequent hot compaction or working to produce an acceptable microstructure and consistent mechanical properties.

It is therefore desirable to provide an improved method for producing an oxide dispersion strengthened nickel-base superalloy.

According to the invention, there is provided a method of producing an oxide dispersion strengthened nickel-base superalloy, comprising: introducing an oxide dispersoid material into a plasma gun of a plasma spray apparatus, where it is sublimed and turned to vapour; and introducing a nickel-base superalloy material into the plasma spray apparatus at a cooler location, downstream of the plasma gun, such that the oxide dispersoid material condenses on the superalloy material to produce the oxide dispersion strengthened nickel-base superalloy.

Preferably, the oxide dispersoid material and/or the nickel-base superalloy is introduced into the plasma spray apparatus as a powder. The oxide dispersoid material may be Y₂O₃ or HfO₂, or similar. The nickel-base superalloy material may be, for example, RR1000, N18, U720Li, U720Li-LG, Rene95, Rene88DT, ME3, Alloy 10 or LSHR.

In one embodiment, a continuous film of oxide phase is formed on the nickel-base superalloy material. Alternatively, discrete islands of oxide phase are formed on the nickel-base superalloy material. The discrete islands may be formed by varying the relative amounts of oxide dispersoid material and nickel-base superalloy material injected into the plasma spray apparatus. Alternatively, they may be formed by varying the temperature of the plasma. As a further alternative, the feed rate of one or both materials into the apparatus could be varied. As a still further alternative, the relative distance between the plasma gun and the insertion of the nickel-base superalloy material could be varied. A combination of these methods may also be used.

The method may further comprise collecting the oxide dispersion strengthened nickel-base superalloy and blending the oxide dispersion strengthened nickel-base superalloy with a virgin superalloy powder.

The method may still further comprise forming a nickel-base superalloy component by isostatic pressing, extrusion, forging or heat treatment. The nickel-base superalloy component may be a gas turbine component, such as a turbine disc or turbine blade.

Advantageously, by combining the superalloy and the oxide phase according to embodiments of the invention, as opposed to conventional ball milling, it is possible to achieve a dispersion of oxide phase within a metallic matrix in a high γ′ volume fraction nickel-base superalloy.

Further, a finer distribution of oxide particles, in the size range of tertiary γ′, may be realized. These provide an impediment to dislocation motion with the advantage of not coarsening during long exposure at high temperatures.

In addition, the process enables a high throughput of material compared to ball milling.

Also, the size and distribution of the oxide can be adjusted such that oxide in the typical size range of primary γ′ can be produced, which would act to restrain grain growth allowing a greater proportion (or even entirety) of the primary γ′ to be released as secondary and tertiary.

Still further, it provides the ability to selectively place the oxide particles on the surface of the powder. Subsequent to consolidation, the surfaces of the particles tend to form the grain boundaries of the material. The presence of oxide particles on the grain boundaries reduces grain boundary diffusion and potentially improves creep properties of the material. The presence of particles may also improve tensile properties.

Reference is now made, by way of example only, to the accompanying drawings, in which:

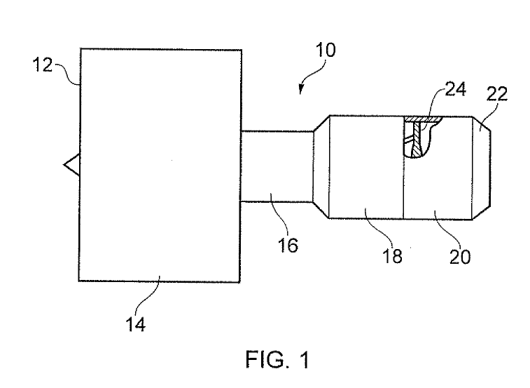

FIG. 1 shows a turbofan gas turbine engine having a turbine disc comprising a nickel-base superalloy;

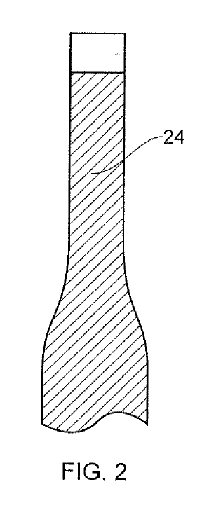

FIG. 2 shows an enlarged view of a turbine disc comprising a nickel-base superalloy;

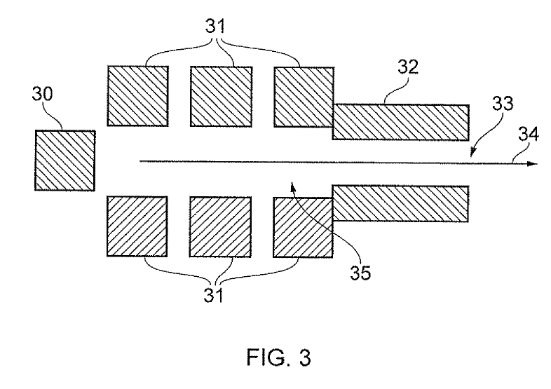

FIG. 3 is a schematic drawing of an example plasma spray gun;

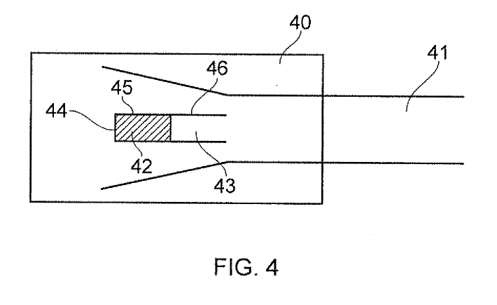

FIG. 4 is a schematic drawing of a plasma spray apparatus including a plasma spray gun.

A turbofan gas turbine engine 10, as shown in FIG. 1, comprises, in axial flow series, an inlet 12, a fan section 14, a compressor section 16, a combustion section 18, a turbine section 20 and an exhaust 22. The turbine section 20 includes one or more turbine discs 24, which are shown in FIG. 2. The turbine discs may be made from a nickel-base superalloy produced according to embodiments of the invention.

FIG. 3 is a schematic drawing of a plasma spray gun. The plasma spray gun includes a cathode 30, a segmented cylindrical anode 31, and an exit region 32, together with an input feed 33 for inputting a material to be sprayed. The gas flow direction is indicated by the arrow 34. A cavity 35 is defined by the anode and the cathode. A power supply, not shown, has its negative output terminal connected to the cathode 30 and its positive output terminal connected to one of the segments of the segmented anode 31. The gas to be ionized is introduced, under pressure, into the cavity 35 and flows in the flow direction 34 to the exit region 32. At the input feed 33, material to be melted and sprayed is fed into the gas stream.

FIG. 4 is a schematic drawing of a plasma spray apparatus including therein a plasma spray gun 42 adjoined by a gun extension 43. Gas tight sound enclosures 40 and 41 are provided also. Arrow 44 indicates the introduction of quench gas, such as Ar or N₂, to the plasma gun 42.

An embodiment of the invention will now be described. The embodiment provides a process for producing an oxide dispersion strengthened nickel-base superalloy suitable for use in a gas turbine component. Two types of raw input material are required as input stock for the process. The first is a conventional nickel-base superalloy. This may be produced by a powder metallurgy route and supplied as loose powder, before being sieved to the final screen size and stored under an inert atmosphere. The second input stock is the oxide dispersoid. This may also be in the form of loose powder. The oxide dispersion material may be Y₂O₃, HfO₂, or similar.

The conventional nickel-base superalloy is preferably RR1000. It may, however, also be a different nickel-base superalloy. Example superalloys and their compositions are outlined in the table below:

TABLE 1

| | U720Li | | | | | | Alloy | |
|---|---|---|---|---|---|---|---|---|
| | U720LG | RR1000 | Rene95 | Rene88DT | ME3 | N18 | 10 | LSHR |
| Ni | bal | bal | bal | bal | bal | bal | bal | bal |
| Co | 15 | 14.0-19.0 | 8.12 | 13.1 | 20.6 | 15.4 | 17.93 | 20.8 |
| Cr | 16 | 14.35-15.15 | 12.94 | 15.8 | 13 | 11.1 | 10.46 | 12.7 |
| Mo | 3 | 4.25-5.25 | 3.45 | 4 | 3.8 | 6.44 | 2.52 | 2.74 |
| W | 1.25 | — | 3.43 | 3.9 | 2.1 | — | 4.74 | 4.37 |
| Al | 2.5 | 2.85-3.15 | 3.42 | 2 | 3.4 | 4.28 | 3.53 | 3.48 |
| Ti | 5 | 3.45-4.15 | 2.44 | 3.7 | 3.7 | 4.28 | 3.79 | 3.47 |
| Ta | — | 1.35-2.15 | — | — | 2.4 | — | 1.61 | 1.65 |
| Nb | — | — | 3.37 | 0.7 | — | — | 0.97 | — |
| Hf | — | 0.5-1.0 | — | — | — | 0.50 | — | — |
| Zr | — | 0.05-0.07 | 0.05 | 0.045 | 0.05 | 0.019 | 0.07 | 0.049 |
| C | 0.015 | 0.012-0.033 | 0.07 | 0.05 | 0.04 | 0.022 | 0.027 | 0.024 |
| B | 0.015 | 0.01-0.025 | 0.012 | 0.016 | 0.03 | 0.008 | 0.028 | 0.028 |

Further, the nickel-base superalloy may consist of 23 to 40 wt % cobalt, 10 to 15 wt % chromium, 3 to 6 wt % molybdenum, 0 to 5 wt % tungsten, 2.5 to 4 wt % aluminium, 3.4 to 5 wt % titanium, 1.35 to 2.5 wt % tantalum, 0 to 2 wt % niobium, 0.5 to 1 wt % hafnium, 0 to 0.1 wt % zirconium, 0.01 to 0.05 wt % carbon, 0.01 to 0.05 wt % boron, 0 to 2 wt % silicon and the balance nickel plus incidental impurities.

The two stock materials are combined in a plasma spray apparatus, for example that shown in FIG. 4. The oxide dispersion, such as Y₂O₃ powder, is introduced directly into the plasma gun, as indicated by the arrow 45 in FIG. 4. In other words, it is injected into the hottest location of the plasma spray apparatus, where the temperature may be ˜25,000 K. The oxide dispersion is sublimed and turned to vapor in the plasma gun.

The nickel-base superalloy, for example RR1000 powder, is injected into the plasma spray apparatus at a cooler location downstream of the plasma gun as indicated by the arrow 46 in FIG. 4. In other words, it is injected into the gun extension 43 as indicated by the arrow 46.

The oxide dispersion, e.g. the Y₂O₃, then condenses on the nickel-base superalloy. Thus, the superalloy powder is coated with the oxide. In this regard, the superalloy powder typically has a diameter of 100 μm or less, and the oxide phase coating is less than 100 nm, typically less than 40 nm thick.

The superalloy powder may be coated in the form of a continuous film of oxide phase. Alternatively, a semi or discontinuous arrangement may be used where discrete islands of oxide phase are formed on the superalloy powder surface. The semi or discontinuous arrangement may be realized, for example, by varying the relative amounts of oxide dispersion powder and nickel-base superalloy powder injected into the plasma spray apparatus. Alternatively, it may be realized by varying the temperature of the plasma. As a further alternative, it may be realized by varying the feed rate of one or both powders into the apparatus. Another alternative is varying the relative distance between the plasma gun and the insertion of the nickel superalloy powder.

The resulting composite powder is then collected. This may subsequently be blended with virgin superalloy powder such that a desired volume fraction of oxide is achieved in the final billet.

The blended material can then be further processed using standard processing techniques for production of powder metallurgy nickel-base superalloy components. These techniques include hot isostatic pressing, extrusion, forging and heat treatment. The blended material may be hot isostatically pressed and heat treated during or after the hot isostatic pressing process. The blended material may be extruded and heat treated during or after the extrusion process. The blended material may be forged and heat treated during or after the forging process.

Similarly the composite powder alone may be further processed using the standard processing techniques for production of powder metallurgy nickel-base superalloy components as mentioned above and in particular hot isostatic is pressing, extrusion forging and heat treatment in the manner described in the previous paragraph.

In this way, the oxide dispersion strengthened nickel-base superalloy can be used for forming gas turbine components such as a turbine disc or turbine blade.

1. A method of producing an oxide dispersion strengthened nickel-base superalloy, comprising:
introducing an oxide dispersoid material into a plasma gun of a plasma spray apparatus, where it is sublimed and turned to vapour; and
introducing a nickel-base superalloy material into the plasma spray apparatus at a cooler location, downstream of the plasma gun in the flow direction, such that the oxide dispersoid material condenses on the nickel-base superalloy material to produce the oxide dispersion strengthened nickel-base superalloy.

2. A method according to claim 1, wherein the oxide dispersoid material is introduced into the plasma spray apparatus as a powder.

3. A method according to claim 1, wherein the nickel-base superalloy is introduced into the plasma spray apparatus as a powder.

4. A method according to claim 1, wherein the oxide dispersoid material is Y₂O₃ or HfO₂.

5. A method according to claim 1, wherein the nickel-base superalloy material is RR1000, N18, U720Li, U720Li-LG, Rene95, Rene88DT, ME3, Alloy 10 or LSHR.

6. A method according to claim 1, wherein a continuous film of oxide phase is formed on the nickel-base superalloy material.

7. A method according to claim 1, wherein discrete islands of oxide phase are formed on the nickel-base superalloy material.

8. A method according to claim 1, further comprising:
collecting the oxide dispersion strengthened nickel-base superalloy; and
blending the oxide dispersion strengthened nickel-base superalloy with a virgin nickel-base superalloy powder.

9. A method according to claim 1, further comprising:
forming a nickel-base superalloy component using a process selected from the group consisting of isostatic pressing, extrusion and forging.

10. A method according to claim 9, further comprising a heat treatment.

11. A method according to claim 9, wherein the nickel-base superalloy component is a gas turbine component.

12. A method according to claim 11, wherein the gas turbine component is a turbine disc.

13. An oxide dispersion strengthened nickel-base superalloy produced by the method of claim 1.

14. A gas turbine component produced by the method of claim 9.

15. A gas turbine component according to claim 13, wherein the gas turbine component is a turbine disc.

16. A method of producing an oxide dispersion strengthened nickel-base superalloy component, comprising the steps of:—
a) introducing an oxide dispersoid material into a plasma gun of a plasma spray apparatus, where the oxide dispersoid material is sublined and turned to a vapour,
b) introducing a nickel-base superalloy material into the plasma spray apparatus at a cooler location, downstream of the plasma gun in a flow direction, such that the oxide dispersoid material condenses on the nickel-base superalloy material,
c) collecting the oxide dispersion strengthened nickel-base superalloy,
d) blending the oxide dispersion strengthened nickel-base superalloy with a virgin nickel-base superalloy powder, and
e) forming a nickel-base superalloy component from the blend of oxide dispersion strengthened nickel-base superalloy and virgin nickel-base superalloy powder using a process selected from the group consisting of isostatic pressing, extruding and forging.

17. A method of producing an oxide dispersion strengthened nickel-base superalloy component, comprising the steps of:—
a) introducing an oxide dispersoid material into a plasma gun of a plasma spray apparatus, where the oxide dispersoid material is sublimed and turned to a vapour,
b) introducing a nickel-base superalloy material into the plasma spray apparatus at a cooler location, downstream of the plasma gun in a flow direction, such that the oxide dispersoid material condenses on the nickel-base superalloy material,
c) collecting the oxide dispersion strengthened nickel-base superalloy,
d) forming a nickel-base superalloy component from the oxide dispersion strengthened nickel-base superalloy using a process selected from the group consisting of isostatic pressing, extruding and forging.
